(19) United States
(12) Patent Application Publication
(10) Pub. No.: US 2020/0242704 A1
(43) Pub. Date: Jul. 30, 2020

(54) SYSTEM AND METHOD FOR DISTRIBUTION OF PAYMENTS FROM PAYROLL

(71) Applicant: Brightside Benefit, Inc., San Francisco, CA (US)

(72) Inventors: Callum Lachlan King, San Francisco, CA (US); Jacky Yuk Ming Chiu, Chandler, AZ (US)

(73) Assignee: Brightside Benefit, Inc.

(21) Appl. No.: 16/773,816

(22) Filed: Jan. 27, 2020

Related U.S. Application Data
(60) Provisional application No. 62/798,882, filed on Jan. 30, 2019.

(51) Int. Cl. G06Q 40/00; G06Q 40/02; G06Q 10/10

(52) U.S. Cl. CPC G06Q 40/125; G06Q 10/1057; G06Q 40/02

(57) ABSTRACT

A system, method, and device for automatic distribution of payments are provided. The automatic distribution of payments includes receiving funds from a payment source, the funds being for the benefit of one or more third parties, distributing, automatically, the received funds to one or more custodial accounts associated with each of the one or more third parties, allocating, automatically, the distributed funds from the one or more custodial accounts associated with each of the one or more third parties, to one or more custodial accounts associated with at least one partner, wherein the allocation of the distribute funds is based on instructions previously received from one or more of the third parties, and transferring, automatically, the allocated funds to a separate banking institution based on previously received instructions the at least one partner.

### BACKGROUND

### Field

The present disclosure relates to payroll distribution, and more specifically, to systems and methods for automatically distributing payroll payments to partners based on instructions provided by employees.

### Related Art

Many employees use automatic debits or electronic payments from their bank accounts to pay recurring bills such as loan payments, utility bills, savings account/retirement account contributions, etc. Further, many employees of the same employer may be making these automatic debits or electronic payments to the same end parties (e.g., same loan holder, same utility company, same savings/retirement account manager, etc.). This situation may result in an inherent inefficiency of transactions with all of the funds starting out in a single employer's payroll distribution, being transferred to individual employee's bank accounts, and transferred from multiple employees' bank accounts into the same account held by the end party (e.g., same loan holder, same utility company, same savings/retirement account manager, etc.). Each such transfer may have potential transfer fees and other costs (both monetary and non-monetary costs, such as transaction tracking costs). Existing payroll management systems do not provide any mechanisms that could address these inherent inefficiencies.

### SUMMARY OF THE DISCLOSURE

Aspects of the present application may provide is a system that enables a flow of funds that that allows a platform provider to receive funds from one place (e.g., an employer) on behalf of a set of entities (employee) and then distribute those funds to another set of entities (end payees, herein called “partners”) and then have the entities (“partners) be paid with an individual lump sum with the platform returning any remainder back to the employee.

### BRIEF DESCRIPTION OF THE DRAWINGS

FIG. 1 illustrates a flow chart of payment distributions generally in accordance with example implementations of the present application.

FIGS. 2 and 3 illustrate flow charts of a process for payment distributions based on employee instructions in accordance with example implementations of the present application.

FIG. 4 illustrates a schematic representation of a payment distribution system in accordance with example implementations of the present application.

FIG. 5 illustrates a payment and data flow diagram in accordance with Example implementations of the present application.

FIG. 6 illustrates an example computing environment with an example computer device suitable for use in some example implementations of the present application.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application. Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

In the present application, the terms computer readable medium may include a local storage device, a cloud-based storage device, a remotely located server, or any other storage device that may be apparent to a person of ordinary skill in the art.

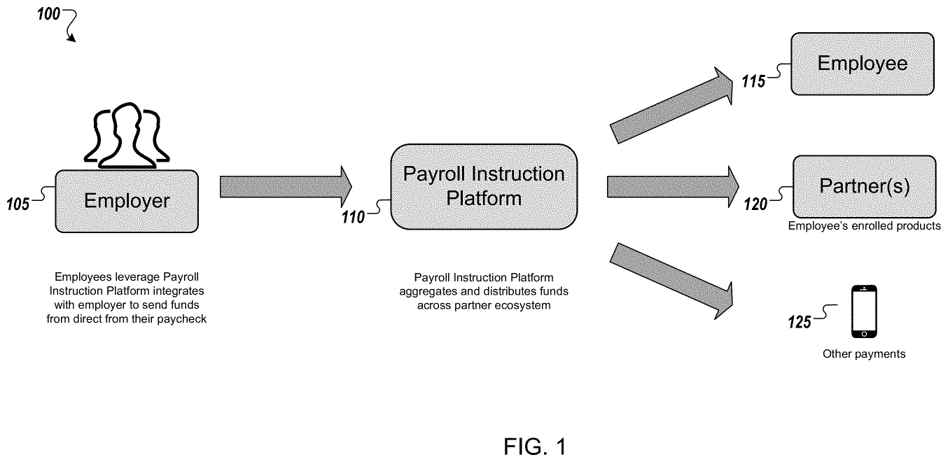

FIG. 1 illustrates a flow chart 100 of payment distributions generally in accordance with example implementations of the present application. As illustrated, the payroll platform may provide the ability for an employer 105 to have one lump sum sent to the platform infrastructure 110, for example at a paycheck period, then through the employer's instructions, allocate the lump sum into custody accounts associated with individual employees 115. Further, the platform may allocate funds from the custody accounts associated with the employees to custody accounts associated with partners 120 (end payees) and other payment plans 125, based on previously received instructions from the employees. Finally, once all of the funds to be allocated based on the employee instructions have been allocated, the platform would send the allocated funds from each partner custody account to the partner's actual underlying bank account. Further, in some example implementations, any unallocated funds (e.g., funds in excess of the specific allocation instructions provided by the client) remaining in the custody accounts associated with individual employees are transferred to the individual employee's personal bank accounts. In other words, once the funds the employees have instructed to be allocated to the partners have been transferred, all remainder funds are returned to the employees. For purposes of illustration, more detailed examples are discussed below and illustrated in the attached figures.

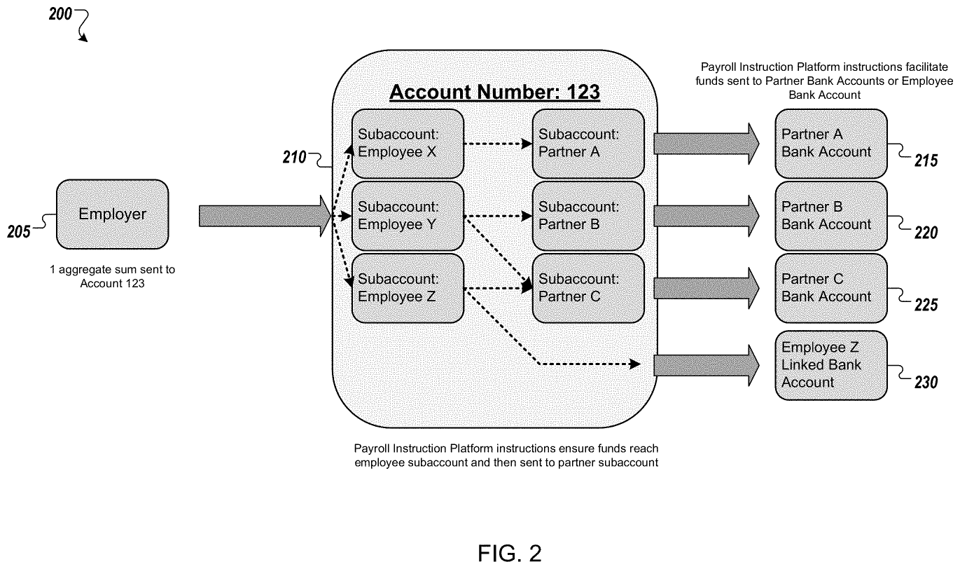

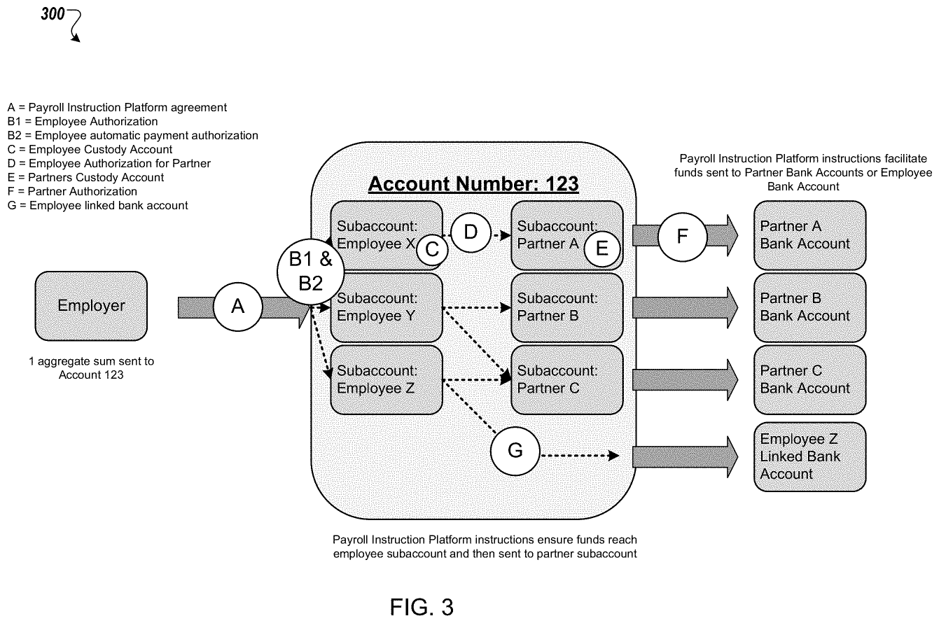

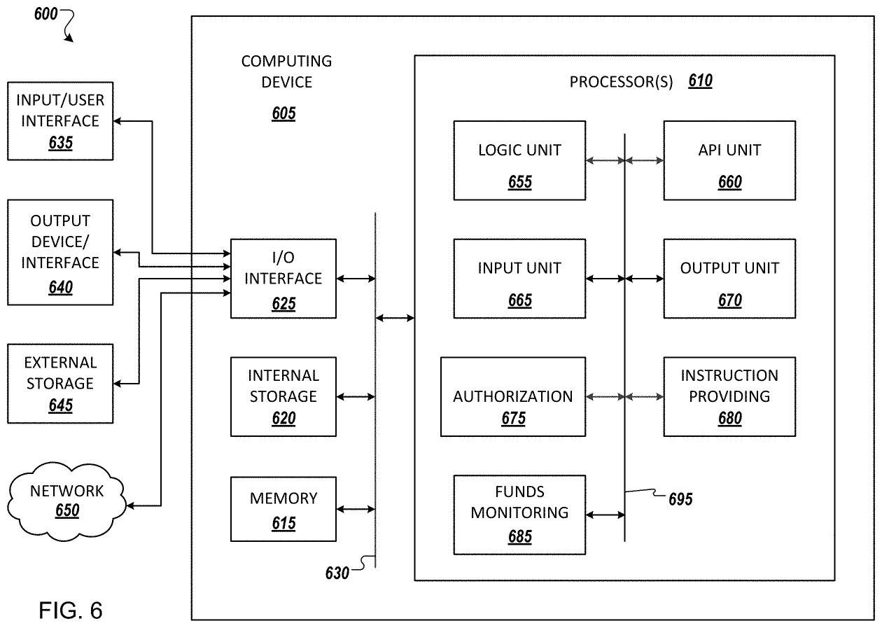

FIGS. 2 and 3 illustrate flow charts of a process 200, 300 for payment distributions based on employee instructions in accordance with example implementations of the present application. In the illustrated examples, the platform may be implemented by one or more computing devices, such as computing device 605 of the computing environment 600 discussed below with respect to FIG. 6.

As illustrated in FIGS. 2 and 3, an employer 205 may have three employees (X, Y, and Z). From the Employer's lump sum payroll transfer, each employee's paychecks are allocated into a subaccount 210 associated with each employee. Based on instructions provided by each employee, the platform may deduct a defined amount (e.g., $25) from each employee's paycheck and send those $25 to different partners (Partners A, B, and C, shown at 215, 220, 225, 230). For example, Employee may send $75 in one lump sum to the payroll infrastructure. The payroll infrastructure would split that $25 and put it into each employee's own custody account. Then, that $25 would get allocated to another custody account associated with a partner. For example, Employees Y and Z, may both choose $25 payments are going to one partner (Partner C), and for that one partner, $50 may be allocated to Partner C's subaccount. Once all of the allocations of the payroll from the lump sum received from the employer have been completed, the platform will send that $50 in Partner C's subaccount to Partner C's actual bank account to receive those funds.

Thus, the payroll infrastructure has facilitated one lump sum coming out of an employer's payroll on behalf of multiple employees to end up in a multitude of different partners and bank accounts. Further, the platform provider has not actually taken ownership of those funds, which were held in custody account infrastructure that has been put in place. Instead, the platform has merely provided allocation instructions to processors at a bank that is managing the custody account associated with the employer.

Further, in some example implementations, one or more employees may elect to have more than their expected partner allocated transferred to their custody account. In such implementations, the funds in excess of the allocations may be transferred to a linked bank account specified by the employee (e.g., the employee's personal bank account). For example, Employee Z may specify that any excess funds in his or her custody account be transferred to the linked bank account they have identified (e.g., Employee Z's personal checking account).

As illustrated in FIG. 3, the employer may enter into a payroll instruction platform agreement A with the payroll instruction platform provider to provide the funds distribution capability. Further, each employee may provide authorizations B1, B2 to participate on the platform and to automatically make payments to and from their paycheck into their custody account C. Specifically, each employee may provide an authorization B1 to participate in the payroll instruction platform and an automatic payment authorization B2 to authorize payments be sent to one or more partners. Based on the employee's authorizations D for respective partners, the platform will distribute the funds from the employee custody account C to the partner custody account E. Further, the platform will distribute funds from the partner custody account E to the Partner's bank account based on a partner authorization F. Finally, if there are any excess funds in any of the employee's custody account after the distributions authorized with the employee authorizations D, the payroll instruction platform will distribute the excess funds to each employee's linked bank account G.

In some example implementations, the custodian accounts C and E associated with one or more of the individual employees and individual partners may be subaccounts with the employer's payroll account. In other example implementations, the custodian accounts C and E associated with one or more of the individual employees and individual partners may be completely separate accounts at the same financial institution.

As described above, in some example implementations, an employee may specify more than their anticipated partner payments, or even the entire paycheck of said employee be processed through the platform. In such example implementations, any remainder in the individual employee's custodian account may be distributed to the employee's regular banking account once all partner allocations and distributions have occurred. In other example implementations, only a portion of the employee's paychecks that is anticipated to be distributed to the partners may be processed through the platform. For example, each employee may specify a specific amount or percentage from their paychecks to be distributed through the platform, with the remainder of the paycheck being distributed to the employee's bank account independent of the payroll instruction platform.

Further, in some example implementations, the subaccounts associated with the employee may be specific to the employee such that if any employee has multiple jobs, each registered with the platform, the employee may have only a single subaccount on the platform. Similarly, the subaccounts associated with the partner may be specific to the partner such that if each partner may have only a single subaccount on the platform for all employers and employees registered with the platform. For example, a utility provider may have a single subaccount that receives allocations from multiple employees associated with different employers on the platform.

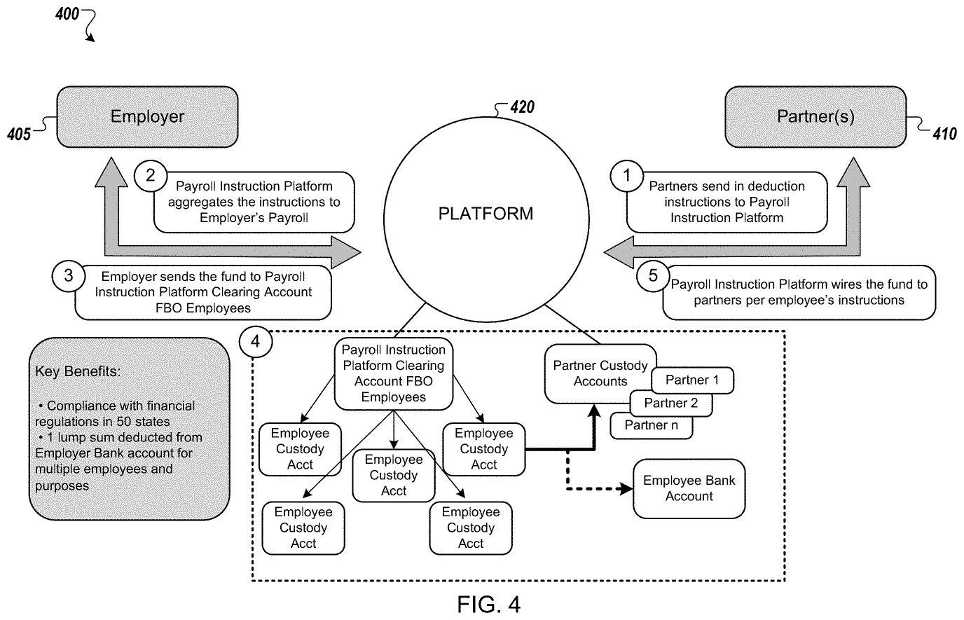

FIG. 4 illustrates a schematic representation of a payment distribution system in accordance with example implementations of the present application. In the illustrated examples, the system may be implemented by one or more computing devices, such as computing device 605 of the computing environment 600 discussed below with respect to FIG. 6.

As illustrated in the flowchart 400 shown in FIG. 4, the partners 410 send in deduction and payment instructions to the platform 420 through flow 1. Platform aggregates instructions for the employer's 405 payroll distribution received through flow 2. During each payment cycle, the employer sends funds to the platform clearing account for the benefit of the employer's employees through flow 3. During flow 4, the platform distributes the received funds to the employee's clearing accounts, and allocates funds from the employee's clearing accounts to partner custody accounts based on employee provided authorizations. Any excess funds not allocated to any partner custody accounts may be distributed to the employee's personal bank account. Finally, the platform wires funds from the partner's custody accounts to the partner's bank accounts based on the employee's instructions at flow 5.

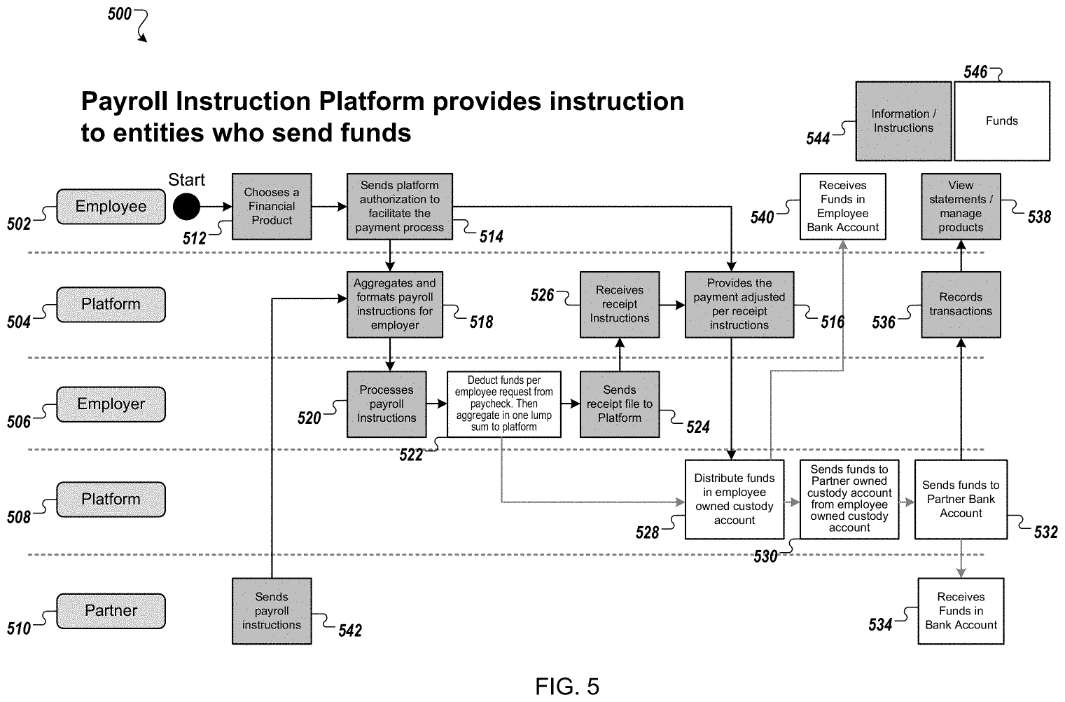

This platform system may have the benefit of complying with current financial regulations in 50 states because the platform does not ever take possession of the funds and the platform does not exhibit any control over the funds. Instead, it simply executes instructions provided by the employee's and partners based on the employee's and partner's authorizations. This is further illustrated in FIG. 5 below. Additionally, this system may also allow a single, lump sum from the employer's bank to deduct from the Employer's account on behalf of multiple employees and distributed for multiple purposes (e.g., payments to multiple partners).

FIG. 5 illustrates a payment and data flow diagram in accordance with Example implementations of the present application. In the illustrated examples, the system may be implemented by one or more computing devices, such as computing device 605 of the computing environment 600 discussed below with respect to FIG. 6.

As illustrated in FIG. 5, grey boxes are representative of instructions or authorizations 544 distributed between the involved parties. Further, white boxes are representative of funds 546 transferred between the involved parties. As the white boxes illustrate, funds are transferred from the employer to a custodian bank associated with the platform, but are not under the platform's possession or control. These funds are then distributed to employee owned custody accounts, allocated from the employee owned custody accounts to provider owned custody accounts, and the transferred either to the partner's bank account or the employee's personal bank account. Ownership of the funds is never transferred to the platform.

As shown in FIG. 5, an employee 502 may choose a financial product at 512. Then, once the financial product is chosen, the platform authorization is sent at 514 to facilitate the payment process. Then, at 516, the platform may aggregate and format payroll instructions for the employer, and provide the payment adjusted per receipt instructions. Simultaneously, at 542, a partner may send payroll instructions, which may then be aggregated and formatted for the employer 506 via the platform 504 at 518.

Once the platform aggregates or formats payroll instructions for the employer at 518, the employer 506 may then process the payroll instructions at 520, deduct funds per the employee's 502 request from the paycheck and aggregate the funds into one lump sum to the platform at 522, and send the receipt file to the platform at 524.

At 526, the platform 504 may then receive receipt instructions from 524, and provide the payment adjusted amount per received instructions, at 516.

From 522 or 516, the platform 508 may distribute funds in the employee-owned custody account at 528. Then, the platform may either send the funds to the partner-owned custody account from the employee-owned custody account at 530, or the employee may receive the funds in the employee Bank Account at 540. Platform 508 may be the same platform as platform 504 in some example implementations. In other example implementations, separate platforms may be used such as illustrated in FIG. 5 to more clearly demonstrate the flow of data. In some example implementations, 524 and 528 may occur simultaneously after 522 has been completed.

After the funds are sent to the partner-owned custody account at 530, the platform 504, 508 may then send the funds to the partner Bank Account at 532. Then, at 534, the funds may be received in the partner 510 Bank Account at 534. Simultaneously, the platform 504, 508 may record transactions at 536. For example, once the fund transfer gets initiated at 532, the platform 504 records the transaction at 536. Then, the platform 508 may check the status of the fund to ensure completion of the process (e.g., that the funds are received in the bank account at 534).

If the platform 504 records the transactions at 536, then the employee 502 may view the statements and manage the products at 538. The products may include, but are not limited to, payroll-linked savings, emergency loans, personal loans, and other similar products of this type. The employee 502 may see the completed transactions in an application such as a mobile application that feeds from the platform's API.

In some example implementations, steps 514-516 may be performed optionally. Further, in some example implementations, 530 and 516 may be performed simultaneously after step 522 has been performed. Thus, an employee may designate the fund distributes to partner(s) based on their selected product(s) and/or their own account.

In a case where there is a failure in advancing to a next step shown in the flow chart, the platform will attempt to repeat the failed step or create an exception for that step in the process.

### Example Computing Environment

FIG. 6 illustrates an example computing environment 600 with an example computer device 605 suitable for use in some example implementations. Computing device 605 in computing environment 600 can include one or more processing units, cores, or processors 610, memory 615 (e.g., RAM, ROM, and/or the like), internal storage 620 (e.g., magnetic, optical, solid state storage, and/or organic), and/or I/O interface 625, any of which can be coupled on a communication mechanism or bus 630 for communicating information or embedded in the computing device 605.

Computing device 605 can be communicatively coupled to input/interface 635 and output device/interface 640. Either one or both of input/interface 635 and output device/interface 640 can be a wired or wireless interface and can be detachable. Input/interface 635 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 640 may include a display, television, monitor, printer, speaker, braille, or the like. In some example implementations, input/interface 635 (e.g., user interface) and output device/interface 640 can be embedded with, or physically coupled to, the computing device 605. In other example implementations, other computing devices may function as, or provide the functions of, an input/interface 635 and output device/interface 640 for a computing device 605. These elements may include, but are not limited to, well-known AR hardware inputs so as to permit a user to interact with an AR environment.

Examples of computing device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 605 can be communicatively coupled (e.g., via I/O interface 625) to external storage 645 and network 650 for communicating with any number of networked components, devices, and systems, including one or more computing devices of the same or different configuration. Computing device 605 or any connected computing device can be functioning as, providing services of, or referred to as a server, client, thin server, general machine, special-purpose machine, or another label.

I/O interface 625 can include, but is not limited to, wired and/or wireless interfaces using any communication or I/O protocols or standards (e.g., Ethernet, 802.11xs, Universal System Bus, WiMAX, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computing device 605 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 655, application programming interface (API) unit 660, input unit 665, output unit 670, context authorization unit 675, instruction providing unit 680, funds monitoring unit 685, and inter-unit communication mechanism 695 for the different units to communicate with each other, with the OS, and with other applications (not shown).

For example, authorization unit 675, instruction providing unit 680, and funds monitoring unit 685 may implement one or more processes or data flows shown in FIGS. 1-5 above. The described units and elements can be varied in design, function, configuration, or implementation and are not limited to the descriptions provided.

In some example implementations, when information or an execution instruction is received by API unit 660, it may be communicated to one or more other units (e.g., authorization unit 675, instruction providing unit 680, and funds monitoring unit 685). For example, authorization unit 675 may collect, store, and update authorizations received from employers, employees and partners. Further, the funds monitoring unit 685 may detect funds received from the employer and inform the instruction providing unit 680. The instruction providing unit 680 may generate instructions and send them to custodial bank based on the stored authorizations collected and updated by the authorization unit. As the instruction providing unit 680 provides instructions to custodial bank, the funds monitoring unit 685 may continue to monitor the funds to determine when distribution and allocation has been completed, and in the event of any remainders in an employee's custody account after all allocations have been completed, instruct the remainder funds be transferred to the respective employee's personal bank account.

In some instances, the logic unit 655 may be configured to control the information flow among the units and direct the services provided by API unit 660, input unit 665, authorization unit 675, instruction providing unit 680, and funds monitoring unit 685 in some example implementations described above. For example, the flow of one or more processes or implementations may be controlled by logic unit 655 alone or in conjunction with API unit 660.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

We claim:

1. A computer assisted method of automatic distribution of payments, the method comprising:
Receiving funds from a payment source, the funds being for the benefit of one or more third parties;
Distributing, automatically, the received funds to one or more custodial accounts associated with each of the one or more third parties;
Allocating, automatically, the distributed funds from the one or more custodial accounts associated with each of the one or more third parties, to one or more custodial accounts associated with at least one partner, wherein the allocation of the distribute funds is based on instructions previously received from one or more of the third parties; and
Transferring, automatically, the allocated funds to a separate banking institution based on previously received instructions the at least one partner.

2. The method of claim 1, wherein the distributing of the received funds to one or more custodial accounts comprises:
Aggregating and formatting payroll instructions;
Processing the payroll instructions; and
Deducting funds from the funds received from the payment source.

3. The method of claim 2, further comprising:
Generating and sending a receipt file showing the deducted funds.

4. A non-transitory computer readable medium encoded with instructions for making a computing device execute a method of automatic distribution of payments, the method comprising:
Receiving funds from a payment source, the funds being for the benefit of one or more third parties;
Distributing, automatically, the received funds to one or more custodial accounts associated with each of the one or more third parties;
Allocating, automatically, the distributed funds from the one or more custodial accounts associated with each of the one or more third parties, to one or more custodial accounts associated with at least one partner, wherein the allocation of the distribute funds is based on instructions previously received from one or more of the third parties; and
Transferring, automatically, the allocated funds to a separate banking institution based on previously received instructions the at least one partner.

5. The method of claim 4, wherein the distributing of the received funds to one or more custodial accounts comprises:
Aggregating and formatting payroll instructions;
Processing the payroll instructions; and
Deducting funds from the funds received from the payment source.

6. The method of claim 5, further comprising:
Generating and sending a receipt file showing the deducted funds.

7. A computing device comprising:
a storage device storing network data associated with a target network and a background network; and
a processor encoded with instructions to execute a method of automatic distribution of payments, the instructions comprising:
receiving funds from a payment source, the funds being for the benefit of one or more third parties;
distributing, automatically, the received funds to one or more custodial accounts associated with each of the one or more third parties;
allocating, automatically, the distributed funds from the one or more custodial accounts associated with each of the one or more third parties, to one or more custodial accounts associated with at least one partner, wherein the allocation of the distribute funds is based on instructions previously received from one or more of the third parties; and
transferring, automatically, the allocated funds to a separate banking institution based on previously received instructions the at least one partner.

8. The computing device of claim 7, the instructions further comprising:
aggregating and formatting payroll instructions;
Processing the payroll instructions; and
Deducting funds from the funds received from the payment source.

9. The computing device of claim 8, the instructions further comprising:
Generating and sending a receipt file showing the deducted funds.
